(19) United States
(12) Patent Application Publication
(10) Pub. No.: US 2013/0185431 A1
(43) Pub. Date: Jul. 18, 2013

(54) Uniform Definition, Provision, and Access of Software Services on the Cloud

(71) Applicants: Madhava R. VENKATESH, Chennai (IN); Rajesh Venkatesan, Trichy (IN)

(72) Inventors: Madhava R. VENKATESH, Chennai (IN); Rajesh Venkatesan, Trichy (IN)

(73) Assignee: HCL TECHNOLOGIES LIMITED, Chennai (IN)

(21) Appl. No.: 13/348,844

(22) Filed: Jan. 12, 2012

(51) Int. Cl. G06F 15/173

(52) U.S. Cl. 709/226

(57) ABSTRACT

A method for accessing cloud computing services provided by service providers includes uniformly defining, provisioning, and accessing cloud computing services of multiple genres such as single-tenant, multi-tenant and third party cloud services. The method defines cloud services across genres in a standard manner, acquires cloud services across genres, and provides a unified access and view of all cloud services subscribed by a user. The cloud services are acquired across genres by identifying a provisioning mechanism based on the cloud service genre requested by the user, automatically activating necessary task flow for the identified mechanism, and enabling the user to access the requested service by providing access with a unified Identity and Access Management System.

### TECHNICAL FIELD

The present disclosure relates to accessing cloud computing services provided by various service providers and more specifically to defining, provisioning and accessing cloud computing services across multiple genres such as single-tenant, multi-tenant and third party cloud services.

### BACKGROUND

With the advent of cloud computing, ISVs (Independent Software Vendors) are exploring the possibility of offering their software products on a Service Model. A Services model, also known as SaaS (Software as a Service) model, allows the ISV to move away from the traditional licensing model.

Cloud computing ensures the delivery of computing as a service and not as a product. Cloud computing utilizes a set of shared computing resources where the resources are typically consolidated in one or more date center locations. However, before a cloud computing resource is accessed, a user must provision and/or configure the particular resource. However, with an increase in third party cloud services, there is no easy way for a user to integrate enterprise infrastructure once resources have been provisioned and therefore, no intelligent leveraging of cloud services exists.

### SUMMARY

The terms ‘cloud computing’, ‘cloud computing services’ and ‘cloud services’ have been used interchangeably throughout the disclosure.

Embodiments of the present disclosure relate to uniform definition, provision and access of cloud computing services available. An embodiment of the present disclosure provides a method for uniformly defining, provisioning and accessing cloud computing services of multiple genres such as single-tenant, multi-tenant and third party cloud services. The method, according to the embodiment, comprises defining cloud services across genres in a standard manner, acquiring cloud services across genres and providing a unified access and view of all cloud services subscribed by the user. The step of acquiring cloud services across genres comprises identifying a provisioning mechanism based on the cloud service genre requested by the user, automatically activating necessary task flow for the identified mechanism and enabling the user to access the requested service by providing access with a unified Identity and Access Management System.

According to an embodiment of the present disclosure, the cloud services of all genres may be represented in standard XML format.

In some embodiments, a task flow may be initiated to configure three layers of cloud computing based on the cloud service genre requested. The three layers of cloud computing are infrastructure provisioning layer, platform provisioning layer and application provisioning layer.

According to some embodiments of the present disclosure, the infrastructure provisioning layer and platform provisioning layers may be configured to create an isolated environment for identified single-tenant genre cloud services.

In other embodiments where a multi-tenant cloud service is being provisioned, infrastructure provisioning layers and platform provisioning layers may be queried for ability to accommodate additional provisioning requests in existing instance. In examples of such embodiments, if such accommodation may be possible, the requested service is provisioned out of an existing infrastructure instance itself. If such an accommodation is not possible, then a new infrastructure instance is provisioned and the requested service is provisioned out of the new infrastructure instance.

In some embodiments, the access details sent to the user for access of cloud services may not reveal the genre of the underlying cloud service being consumed by the user.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a flow diagram representation of a method for defining, provisioning and accessing multiple cloud services according to an embodiment of the present disclosure.

FIG. 2 illustrates a detailed flow diagram representation of a method for defining, provisioning and accessing multiple cloud services according to an embodiment of the present disclosure.

### DESCRIPTION OF THE EMBODIMENTS

Additional objects and advantages of the disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate one (several) embodiment(s) of the disclosure and together with the description, serve to explain the principles of the disclosure.

Reference will now be made in detail to the present embodiment(s) (exemplary embodiments) of the disclosure, an example(s) of which is (are) illustrated in the accompanying drawings. Wherever possible, the same reference numbers will be used throughout the drawings to refer to the same or like parts.

The following discussion provides a brief, general description of a suitable computing environment in which various embodiments of the present disclosure can be implemented. The aspects and embodiments are described in the general context of computer executable mechanisms such as routines executed by a general purpose computer e.g. a server or personal computer. The embodiments described herein can be practiced with other system configurations, including Internet appliances, hand held devices, multi-processor systems, microprocessor based or programmable consumer electronics, network PCs, mini computers, mainframe computers and the like. The embodiments can be embodied in a special purpose computer or data processor that is specifically programmed configured or constructed to perform one or more of the computer executable mechanisms explained in detail below.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting.

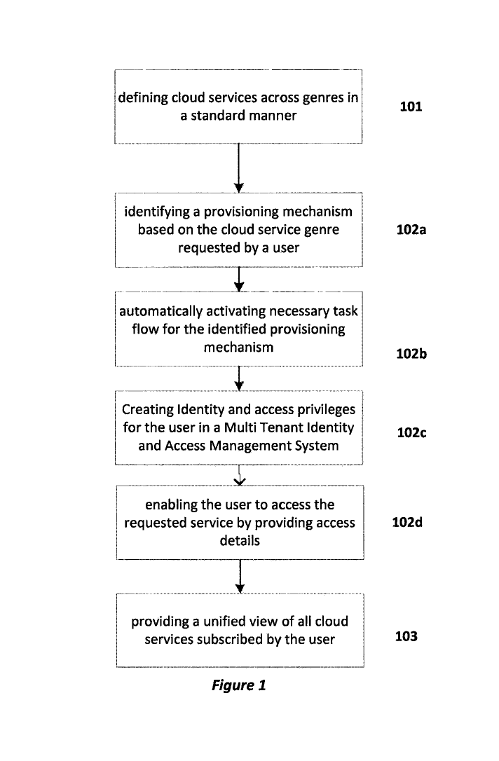

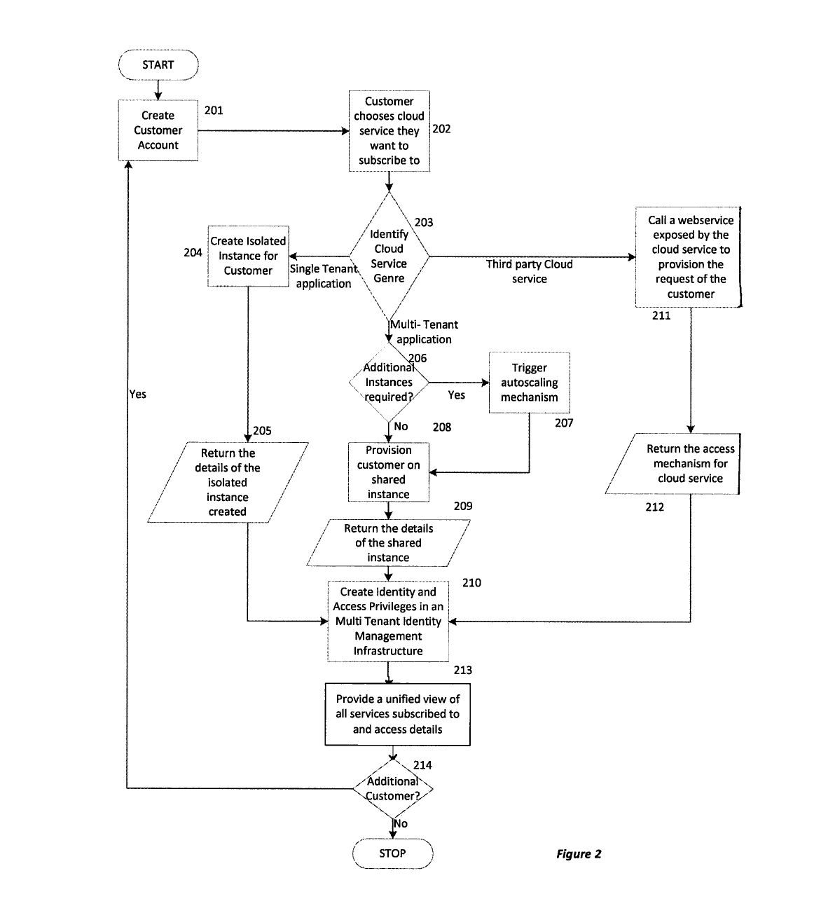

Embodiments of a method for defining, provisioning and accessing multiple genres of cloud services are described in FIGS. 1 and 2. The methods are illustrated as a collection of blocks in a logical flow graph, which represents a sequence of operations that can be implemented in hardware, software, or a combination thereof. The order in which the process is described is not intended to be construed as a limitation, and any number of the described blocks can be combined in any order to implement the process, or an alternate process.

FIG. 1 illustrates a flow diagram representation of a method for defining, provisioning and accessing multiple genres of cloud services according to an embodiment of the present disclosure. According to the embodiment, cloud services are defined across genres in a standard manner 101. Upon such definition of cloud services, the cloud services are acquired 102 once a provisioning mechanism is identified 102a based on the cloud service genre requested by the user, a task flow for the identified provisioning mechanism is automatically activated 102b, creating Identity and Access Privileges for the user in a multi tenant Identity and Access Management System 102c and the user is enabled to access the requested service 102d after the access details are provided. Once, the provisioning and accessing is complete, a unified view of all cloud services subscribed by the user is provided 103.

In some embodiments, the cloud service genres which are defined may comprise single tenant, multi-tenant and third party cloud services. Such cloud service genres may be represented in standard XML format.

In some embodiments, a task flow may be initiated to configure three layers of cloud computing based on the genre of the cloud service requested. The three layers may be infrastructure provisioning layer, platform provisioning layer and application provisioning layer.

According to an embodiment, the infrastructure provisioning layer and/or platform provisioning layer may be configured to create an isolated environment for identified single-tenant genre cloud service. In some embodiments, a policy based infrastructure provisioning later, which is based on the service definition would create either an isolated environment per customer or provision the request in a shared environment. The infrastructure provisioning layer is completely independent of the operating system the layer supports.

In embodiments where the cloud service genre is identified as single-tenant, the infrastructure provisioning layer may create isolated environments for every customer where the isolation may be created through network configuration and firewall configurations.

In embodiments where the cloud service genre is identified as multi-tenant, the infrastructure provisioning layer may provision all requests received within a single instance of the application. The infrastructure provisioning layer also provides an auto-scaling mechanism to provision additional instances when the resources on the existing instance are no longer sufficient to take care of additional loads.

In other embodiments, the application provisioning layer provisions request of every customer irrespective of underlying application tenancy architecture. The application provisioning layer gets the application instance information from the infrastructure provisioning to identify the right instance where the customer request/account has to be provisioned.

In embodiments, where the cloud service genre is identified as third party cloud service, a standard web service based provisioning layer is provided to create account information. In an example of the embodiment, a Federated Identity Management layer will take care of provisioning when the end customer accesses the services for the first time.

In several embodiment, a unified status view of the provisioning is provided which allows the service provider to get status on various provisioning tasks and also perform actions such as restart or abort a specific provisioning step. The provisioning rules for resources may be configured as part of the unified service definition.

In all embodiments, identity and access is provided to the users using a multi tenant identity and access management system that ensures access to the provisioned services.

In other embodiments, an additional web portal interface may redirect the user to the service and may provide the necessary abstraction to the users consuming these services.

FIG. 2 illustrated a detailed flow diagram representation of a method for defining, provisioning and accessing multiple genres of cloud services according to an embodiment of the present disclosure. Embodiments illustrated through the description following FIG. 2 should be read along with the embodiments illustrated through the description following FIG. 1. According to the embodiment, a customer account is created 201 on the platform hosting access to cloud services, so as to enable the customer to subscribe to a cloud service of their choice 202. Subsequently, the genre of the cloud service requested by the user is identified 203 by looking up the Service Definition Information. In embodiments where the identified cloud service genre may be single-tenant application, an isolated instance is created for the customer 204, thereafter the details of the isolated instance created for the customer are returned 205 to provide a unified view of all cloud services subscribed to by the customer 210.

In other embodiments, where the identified cloud service genre may be a multi-tenant application, all customers are provisioned with a single instance of the application. However, according to some embodiments, it may be determined whether additional instances are required 206. The infrastructure provisioning layer provides an auto-scaling mechanism to provision additional instances when the resources on the existing instance are no longer sufficient to take care of additional loads. Accordingly, if in response to the query regarding additional instances, it is received that such additional instances are required, then the auto-scaling mechanism is triggered 207 else the request of the customer is provisioned on a shared instance 208. The details of the provisioning are then returned 209 and Identity and Access is provided to the user in the multi tenant Identity and Access Management System 210 to provide a unified view of all cloud services subscribed to by the customer 213.

In some embodiments, the identified cloud service genre may be third party cloud services following which web service provided by the cloud service is called to provision the request of the customer 211. The details, including access mechanism of the third party cloud service, are returned 212 and Identity and Access is provided to the user in a multi tenant Identity and Access Management system 210 to provide a unified view of all cloud services subscribed to by the customer 213.

Upon defining, provisioning and enabling access of the cloud services according to an embodiment of the present disclosure, if it is determined that an additional customer request for provisioning 214 has been received, then it is determined whether a customer account has been created or not 201.

Implementation of embodiments of the present disclosure provides ease of provisioning and subscription to a service provider and the customer. For the service provider, aggregation of services across the three layers is achieved easily. The abstraction also takes care of services provisioned internally or coming from external third party cloud service providers. For the customer, the ability to use a single platform to gain access to services across all levels.

Additionally, the abstraction layer also reduces time it takes to onboard new services and also onboard new customers. The service provider can move services from one maturity level to the other without impacting the customer experience, thereby making it a seamless transition.

Embodiments of the present disclosure provide a simple yet effective approach for Independent Software Vendors (ISVs) to adopt Software as a Service (SaaS) model at any stage and build upwards. Further, ISVs can also enter the Saas model with a portfolio of products distributed across different maturity levels.

As will be appreciated by one of skill in the art, the present disclosure may be embodied as a method, system, or computer program product. Accordingly, the present disclosure may take the form of an entirely hardware embodiment, a software embodiment or an embodiment combining software and hardware aspects all generally referred to herein as a “circuit” or “module.” Furthermore, the present disclosure may take the form of a computer program product on a computer-usable storage medium having computer-usable program code embodied in the medium.

Furthermore, the present disclosure was described in part above with reference to flowchart illustrations and/or block diagrams of methods, apparatus (systems), and computer program products according to embodiments of the disclosure.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus like a scanner/check scanner to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart representations of FIGS. 1 and 2 illustrate the functionality, and operations of some embodiments of methods, systems, and computer program products of defining, provisioning and accessing multiple genres of cloud services. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the disclosure. Although specific terms are employed, they are used in a generic and descriptive sense only and not for purposes of limitation, the scope of the disclosure being defined by the following claims.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A method for uniformly defining, provisioning, and accessing multiple genres of cloud services comprising:
defining the cloud services across genres in a standard manner;
acquiring the cloud services across genres by:
identifying a provisioning mechanism based on the cloud service genre requested by a user;
automatically activating necessary task flow for the identified provisioning mechanism; and
enabling the user to access the requested service by providing access details;
appropriately providing identity and access control for the cloud services; and
providing a unified view of all cloud services subscribed by the user.

2. The method of claim 1, wherein the cloud services comprise various genres including single tenant, multi-tenant and third party cloud service genres.

3. The method of claim 1, wherein the cloud services of all genres are represented in standard XML format.

4. The method of claim 1, further comprising the step of initiating a task flow to configure three layers of cloud computing based on the cloud service genre requested.

5. The method of claim 4, wherein the three layers of cloud computing comprise an infrastructure provisioning layer, a platform provisioning layer, and an application provisioning layer.

6. The method of claim 5, wherein the infrastructure provisioning layer and the platform provisioning layers are configured to create an isolated environment for identified single-tenant genre cloud service.

7. The method of claim 5, wherein the infrastructure provisioning layer and the platform provisioning layer are queried for ability to accommodate additional provisioning requests in existing instance while provisioning a multi-tenant cloud service genre.

8. The method of claim 7, further comprising provisioning the additional provisioning requests out of an existing infrastructure instance if the infrastructure provisioning layer and the platform provisioning layer have the ability to accommodate.

9. The method of claim 7, further comprising provisioning a new infrastructure instance for provisioning the additional provisioning request if the infrastructure provisioning layer and the platform provisioning layer do not have the ability to accommodate.

10. The method of claim 1, wherein the access details provided to the user do not reveal the genre of the underlying cloud service.
